(19) United States
(12) Patent Application Publication
(10) Pub. No.: US 2004/0122561 A1
(43) Pub. Date: Jun. 24, 2004

(54) Vehicle sharing system

(76) Inventors: Michio Fujinuma, Sayama-shi (JP); Tomohide Shimizu, Iruma-shi (JP); Mamoru Kokubu, Palm Spring (SG); Yuji Uehara, Utsunomiya-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/472,196

(22) PCT Filed: Mar. 29, 2002
(86) PCT No.: PCT/JP02/03198

(30) Foreign Application Priority Data
Apr. 3, 2001 (JP) 2001-105077

(51) Int. Cl. G06F 17/00

(52) U.S. Cl. 701/1; 701/117

(57) ABSTRACT

When a staff member reports a start of daily work from a portable terminal to a control center, a staff member controlling section which is included in the controlling section starts to handle the staff member. Also, a motor vehicle controlling section which is included in the controlling section acknowledges a maintenance condition of a shared motor vehicle which is recorded in a motor vehicle master and a port master and a partiality condition of the motor vehicles in each port so as to detect a staff member's job which is supposed to be done by the staff member and a port position in which the job is necessary to be done by the staff member. The staff member controlling section selects a staff member who can arrive at the port first in which a new job occurs according to the estimated job completion time at which the staff member completes the present job. A job notifying section which is included in the controlling section notifies the job to the portable terminal of the staff member. By doing this, it is possible to provide a motor vehicle sharing system in which a staff member can be allocated to the staff member's job such as maintenance and reallocation of the motor vehicle efficiently.

### TECHNICAL FIELD

The present invention relates to a controlling system for motor vehicles which are used in common by a plurality of users. In particular, the present invention relates to a motor vehicle sharing system which is the most preferable for a maintenance for ports and motor vehicles, an efficient job instruction to staff members who reallocate the motor vehicles, and a job control.

### BACKGROUND ART

Conventionally, various proposals have been proposed for a motor vehicle sharing system for purposes of efficient usage of motor vehicles by a plurality of users so as to realize smooth transportation.

Among these proposals, for example, a technique is disclosed in Japanese Unexamined Patent Application, First Publication No. Hei 8-44801 in which a motor vehicle rental system which comprises a control center for controlling the motor vehicles according to a data which is sent via communication sections which are carried on each of a plurality of motor vehicles so as to use the motor vehicles in common according to a contract between the user and the control center. Also, furthermore in the publication, a multi-port motor vehicle rental system is proposed in which the above motor vehicles are prepared in a parking area which is called a port, and the users can freely visit these ports by disposing numerous ports. Such a multi-port system is useful for the user because the user can return the motor vehicle at a port which is close to a destination. However, there is a problem in such a multi-port system because there is a traffic congestion near railway stations in the mornings and evenings and at restaurants in lunch time; thus, many motor vehicles come to a near port temporarily. That is, the motor vehicles exist partially in one port. Furthermore, there is a problem in that it is not possible to return a motor vehicle nor park a motor vehicle in a port to which motor vehicles exceeding the parking capacity thereof.

For a conventional technique for solving such a problem for a partiality of the motor vehicles among the ports by equalizing the number of the motor vehicles parked in each port, a technique is disclosed in Japanese Unexamined Patent Application, First Publication No. 2000-132784. According to the publication, it is disclosed that monitoring sections for detecting an excess and deficit of motor vehicles estimated in a planned period of time for each port which is disposed in an area such that excess motor vehicles are reallocated from a port to another port in which there is a great deficit of motor vehicles.

As explained above, in a multi-port motor vehicle sharing system, the user can freely visit the ports by the motor vehicle. Therefore, the motor vehicle is never parked at one particular port; thus, it was difficult to employ a maintenance routine in which the staff members circulate among the ports periodically. Furthermore, the control center controls the motor vehicles on which a communication section for communicating with the control center is carried collectively in which the staff members go to a site such as a port in which a job occurs from the central control center and returns to the control center after the job is completed repeatedly; thus, there was a problem because such a control was not efficient.

Similarly, the partial existence of the motor vehicles does not occur in a particular port; therefore, the staff member must go to a port in which a job occurs from a central control center and must return to the control center repeatedly for reallocating the motor vehicles. Therefore, there was a problem because such a control was not efficient.

The present invention was made in consideration of the above problems. An object of the present invention is to provide a motor vehicle sharing system in which it is possible to allocate staff members efficiently so as to improve job efficiency by the staff members who do jobs such as maintenance and reallocation of the motor vehicles.

### DISCLOSURE OF INVENTION

In order to solve the above problems, the present invention is a motor vehicle sharing system, for controlling a plurality of motor vehicles (for example, shared motor vehicles 2 in an embodiment) such that the motor vehicles can be used by a plurality of users while maintaining condition of a plurality of the motor vehicles which are parked in a plurality of parking areas, which are called ports, by directing a plurality of staff members such that the motor vehicles are rentable, which comprises a controlling device (for example, a control center 1 in an embodiment) which can transmit and receive a motor vehicle data which includes a present position data of the motor vehicle and a maintenance condition with the motor vehicles. In the motor vehicle sharing system, the controlling device comprises a data storing section (for example, a job master 17 in an embodiment) which stores a present position data for the staff member and a job data which are notified from a terminal of the staff member as a staff member data, a motor vehicle controlling section (for example, a motor vehicle controlling section 101 in an embodiment) which detects a position of a port in which a staff member's job such as a maintenance and a reallocation of motor vehicle which are supposed to be done by the staff member occur from the motor vehicle data as a job appearance position data, a staff member controlling section (for example, a staff member controlling section 102 in an embodiment) which selects a staff member who is estimated to be able to arrive at a port which is shown by a job appearance position data in a shortest required time among a plurality of the staff members according to the staff member data and the job appearance position data, and a job notifying section (for example, a job notifying section 103 in an embodiment) which notifies the job appearance position data to a terminal of the staff member which is selected by the staff member controlling section.

According to the above structure, the control center acknowledges a present position of the staff member and a job which is presently being done according to a staff member data which is notified from a terminal of the staff member so as to select the staff member who can complete the present job when a next job occurs so as to instruct the staff member to arrive at a port first in which a new job occurs; thus, the staff member can perform jobs efficiently.

In this case, the data storing section further stores a standard transportation time which is predetermined for each port, and the staff member controlling section determines the required time according to the standard transportation time.

According to the above structure, a standard transportation time for each port is predetermined according to an environment which depends on different factors such as a geographical condition in the port, and traffic conditions therearound. Thus, it is possible to select the most preferable staff member accurately and quickly for the new job because the control center acknowledges a transportation time for the staff member accurately.

Also, the data storing section further stores a standard job time which is predetermined for each staff member's job, and the staff member controlling section determines the required time according to the standard job time.

According to the above structure, a standard job time is predetermined for each staff job by taking different job times for each staff member into account. By doing this, the control center can acknowledge an estimated time of completion of the job which is presently being done by the staff member accurately; thus, it is possible to select the most suitable staff member for the new job accurately and quickly.

Also, the staff member controlling section is provided with a monitor timer for monitoring a time which is required for each staff member to be at a job position and start the job which is notified from the terminal of the staff member and a monitoring section which issues a warning that the staff member is not at the job position and start the job in the predetermined time are disposed.

According to the above structure, a phenomenon which disturbs the staff member's job such as an accident which occurs in an environment around the staff member and the port are found quickly; thus, such an accident is handled appropriately and quickly. By doing this, it is possible to establish a motor vehicle sharing system in which it is possible to prevent staff member's job from being interrupted or delayed such that inconvenience to the users does not occur.

### BRIEF DESCRIPTION OF DRAWINGS

FIG. 1 is a block diagram for a structure used in an embodiment of the present invention.

FIG. 2 shows a structure in a shared motor vehicle which is used in the embodiment.

FIG. 3 shows a port for parking shared motor vehicles which are used in the embodiment.

FIG. 4 shows staff member controlling operations in a control center in the motor vehicle sharing system in the embodiment.

FIG. 5 shows operations of the staff member in the motor vehicle sharing system in the embodiment.

FIG. 6 shows an example for a staff member controlling operation in the motor vehicle sharing system in the embodiment.

### BEST MODE FOR CARRYING OUT THE INVENTION

Hereinafter, an embodiment of the present invention is explained with reference to drawings as follows.

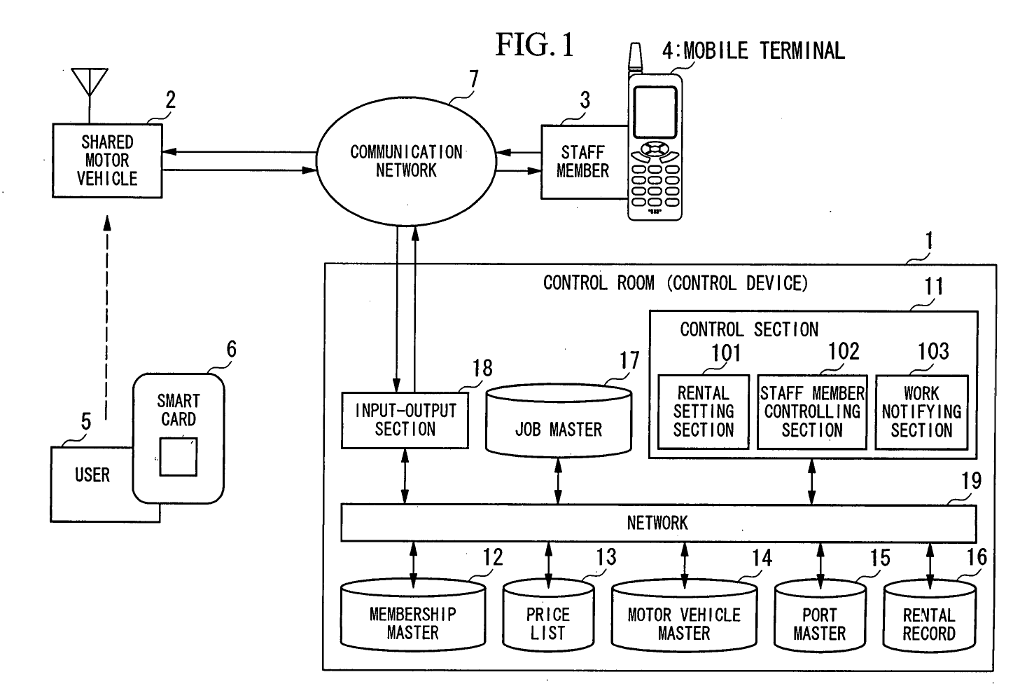

FIG. 1 is a block diagram of a structure in the embodiment of the present invention.

In FIG. 1, a control center 1 is a control center which is provided with a controlling device for controlling the common usage of the shared motor vehicles 2, such as, making a reservation, allocating the motor vehicle, and billing usage price for the motor vehicles 2 which are parked in the parking area, which is called a port, so as to be used commonly by the users. The shared motor vehicles 2 are used in two methods such as a “reserved rental” form and a “non-reserved” form. In the “reserved rental”, a motor vehicle is reserved by designating information for specifying a motor vehicle such as a departing and arriving port, date, time, and a motor vehicle ID when the user A3 who is registered as a membership by the control center 1 make a reservation from a mobile terminal (not shown in the drawing) to the control center 1. In the “non-reserved rental”, a vacant motor vehicle is used directly by a smart card 4 which is owned by a user 3 who is registered as a membership by the control center 1.

Also, in the motor vehicle sharing system in the present embodiment, the staff member 5 has a portable terminal 6 who does a maintenance job for the port and the motor vehicle and a reallocation of the motor vehicle; thus, the shared motor vehicle 2 is controlled and maintained so as to be rented any time.

Also, a communication network 7 connects the control center 1, the shared motor vehicles 2, portable terminals (not shown in the drawing) which are owned by the control center 1 and the user 3, and furthermore portable terminals 6 which are owned by the control center 1 and the staff member 5. In the communication network 7, information is transmitted and received via a wireless communication such as a WAP (Wireless Application Protocol) or a wired communication via internet and a public network.

Here, under the control center 1, more then 1 (one) motor vehicles 2 are controlled. Also, there may be any number of users 3 and the staff members 5.

Also, the mobile terminal (not shown in the drawing) which is owned by the user 3 and the portable terminal 6 have a connecting function to a computer network such as the Internet and a public network via a wireless communication. The mobile terminal which is owned by the user 3 and the portable terminal 6 include not only a mobile terminal such as a portable phone and a PHS (Personal Handyphone System) or a mobile communication terminal, but also a terminal which is connected to a wired communication system. Furthermore, a mobile terminal which is owned by the user 3 and the portable terminal 6 includes a terminal which has a connecting function to a simple computer network in the terminal which uses the above wired communication or wireless communication.

Also, the control center 1 comprises a controlling section 11, a membership master 12, a charge list 13, a motor vehicle list 14, a port master 15, a rental record 16, a reservation master 17, an inputting-outputting section 18, and a network 19.

The controlling section 11 executes a motor vehicle control program in a computer system which is provided with a CPU (Central Processing Unit) and controls overall operations in the control center 1.

Also, in particular, the controlling section 11 comprises a motor vehicle controlling section for controlling a maintenance check and an allocation of the shared motor vehicle 2, a staff member controlling section 102 which controls jobs which occur according to the maintenance check and the allocation of the shared motor vehicle 2 and selects and allocates the staff member 5 who is the most suitable for the occurred job among the staff members who are standing by or doing a job, and a job notifying section 103 which notifies the portable terminal 6 which is owned by the corresponding staff member 5 for the job which is allocated by the staff member controlling section 102. Here, details of operations in the controlling section are explained later.

The membership master 12 is a database for recording registration data for the users who are registered as a membership. In the membership master 12, information such as (1) a user ID, (2) address, and (3) a right of usage for each membership.

The charge list 13 is a database in which a pricing system for a usage of the shared motor vehicle 2 is recorded. In the charge list 13, information such as (1) a basic price, (2) a surcharge, and (3) overcharge and discount charge are recorded.

The motor vehicle master 14 is a database in which information for a condition of the shared motor vehicles for controlling the shared motor vehicles 2 is recorded. For the information for a condition of the shared motor vehicles, information such as (1) motor vehicle number, (2) type and equipment of a motor vehicle, (3) parking position (parking port), and (4) condition are recorded for each shared motor vehicle.

The port master 15 is a database in which a condition regarding the port is recorded for controlling the shared motor vehicle 2. In the port master 15, for example, information such as (1) number of motor vehicles which are parked in the parking area, (2) a parking capacity, and (3) a motor vehicle number which is parked are recorded for each port.

The rental record 16 is a database in which a rental record of the shared motor vehicle 2 is recorded. For example, for such information for each individual user, (1) user ID, (2) motor vehicle number (which is rented), (3) rental time, (4) return time, (5) departure place, (6) return place, (7) driving distance, and (8) used fuel amount are recorded.

A job master 17 is a database in which a job condition and a contents of the job by the staff member are recorded. The job master 17 comprises a job instruction table in which data which are related to a job ID for the job which is supposed to be done by a staff member such as (1) priority, (2) contents of the job, (3) job occurrence time, (4) instruction time, (5) job start time, (6) job completion time, (7) staff member ID, and (8) instruction condition, a staff member control table which is related to the staff member ID for controlling and identifying the staff member for recording the job data such as (1) a portable terminal number, (2) position information which is indicated by the disposition port, and furthermore, (3) job ID, (4) job condition, (5) job start time, (6) total job time, an inter-port transportation time table in which a standard transportation time for each inter-port distance for estimating a transportation time between the ports by the staff member is recorded, and a standard transportation time table in which a standard job time for each job is recorded for estimating the job time of the staff member.

The inputting-outputting section 18 is an interface section in which the control center 1 transmits and receives data regarding a rental reservation of the motor vehicle with a portable terminal (not shown in the drawing) which is owned by the user 3, the control center 1 transmits and receives motor vehicle control data such as data regarding a rental and a return of the motor vehicle with the shared motor vehicle 2, and, furthermore, the control center 1 transmits and receives the job data for the staff member 5 with the portable terminal 6 which is owned by the staff member 5. Here, the motor vehicle control data is transmitted and received directly between the control center 1 and the shared motor vehicle 2 via the wireless communication.

The network 19 forms a LAN (Local Area Network) for transmitting and receiving data. The network 19 connects the controlling section 11, the membership master 12, the charge list 13, the motor vehicle master 14, the port master 15, the rental record 16, the job master 17, and an inputting-outputting section 18 in the control center 1.

Next, the shared motor vehicle 2 which is used in the present embodiment is explained with reference to drawings.

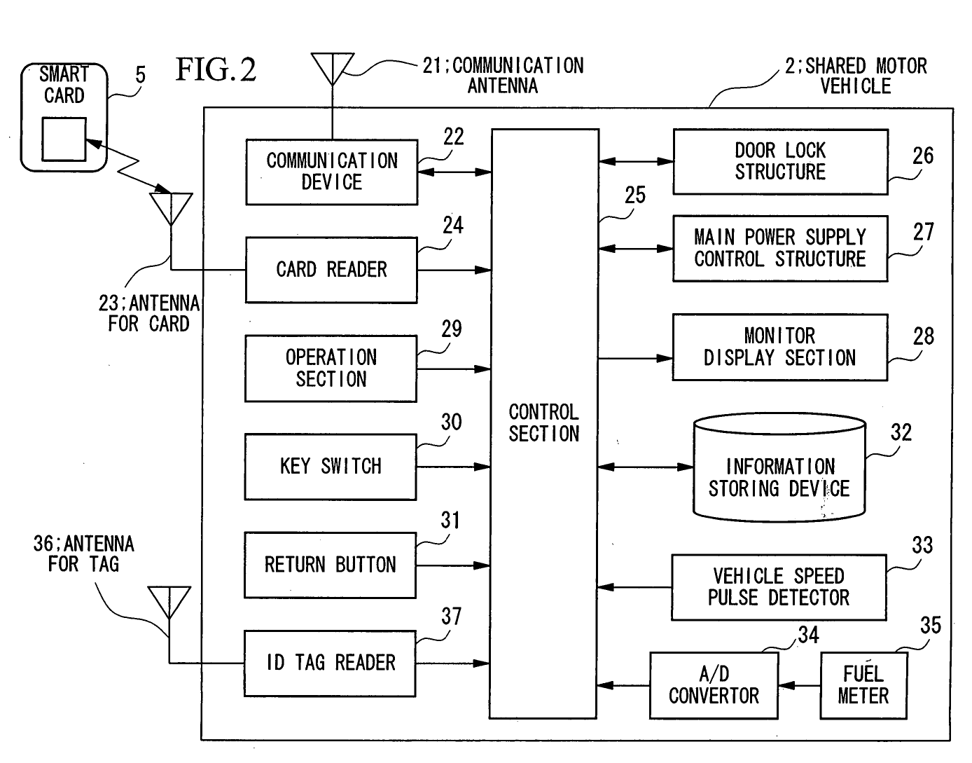

FIG. 2 is a block diagram showing a structure in the shared motor vehicle 2. In FIG. 2, the shared motor vehicle 2 comprises a communication antenna 21, a communicating device 22, an antenna 23 for a card, a card reader 24, a controlling section 25, a door lock structure 26, a main power supply controlling structure 27, a monitor display section 28, an operating section 29, a key switch 30, a return button 31, an information storing device 32, a motor vehicle speed pulse detecting device 33, an A/D converter 34, a fuel meter 35, an antenna 36 for tag, and an ID tag reader 37.

The shared motor vehicle 2 is parked in a parking space which is called a lot for parking one motor vehicle in a parking area which is called as a port. The shared motor vehicle 2 communicates with the control center 1 via the communicating device 22 which is connected to the communication antenna 21 so as to exchange various data.

When the user 3 holds, for example, a non-contacting readable rewritable smart card 6 to the antenna 23 for a card which is disposed in the shared motor vehicle 2, the shared motor vehicle 2 notifies a signal which is read by the card reader 24 to the controlling section 25 which controls operations of the shared motor vehicle 2.

The controlling section 25 communicates with the control center by a wireless communication via the communicating device 22 and the communication antenna 21 and transmits to the control center 1 that the user requested usage of the shared motor vehicle 2 by holding the smart card 6 and requests permission for rental of the motor vehicle.

Also, the information storing device 32 is formed by a ROM (Read Only Memory) and a RAM (Random Access Memory). The information storing device 32 stores an ID number for the motor vehicle which is allocated to each shared motor vehicle 2 in advance and stores an ID number and a PIN (Personal Identification Number) for the user which are inputted by the user temporarily. When the controlling section 25 transmits the ID number of the motor vehicle which is stored in the information storing device 32 and the ID number which is inputted by the user to the control center 1, and a permission for the rental of the shared motor vehicle 2 is issued to the user, the door lock structure 26 releases a door key according to an instruction by the control center 1 to which a rental of the motor vehicle is requested. Also, when a coincidence of the PIN is confirmed in the controlling section 25, the main power supply controlling structure 27 lets an ignition circuit be usable.

The user 3 inputs necessary items to the controlling section 25 from the operating section 29 according to instructions which are displayed on the motor vehicle display section 28 when the shared motor vehicle 2 is rented. Also, the user pushes a return button 31 in the port so as to perform a returning operation when the shared motor vehicle 2 is returned to the port.

Here, the above smart card 6 is an ID terminal which is provided with an IC including a processor which can perform a simple self-determination only by the card. In the above smart card 6, it is possible to read and rewrite the recorded ID number. In the present embodiment, any member can be used for the ID terminal which is used for notifying the ID number to the shared motor vehicle 2. That is, the ID terminal is not limited to those which work according to a non-contacting method or a contacting method; thus, a magnetic card, a portable telephone having a built-in IC chip in which ID number can be read can be used for the ID terminal as long as a reading device in the shared motor vehicle 2 can handle the ID number.

Also, the motor vehicle speed pulse signal which indicates a driving condition of the shared motor vehicle 2 is notified to the controlling section 25 from the motor vehicle speed pulse detecting device 33 while the shared motor vehicle 2 is being driven. Furthermore, a fuel meter 35 is connected to the controlling section 25 via the A/D converter 34 by which the controlling section 25 acknowledges a consumption of fuel.

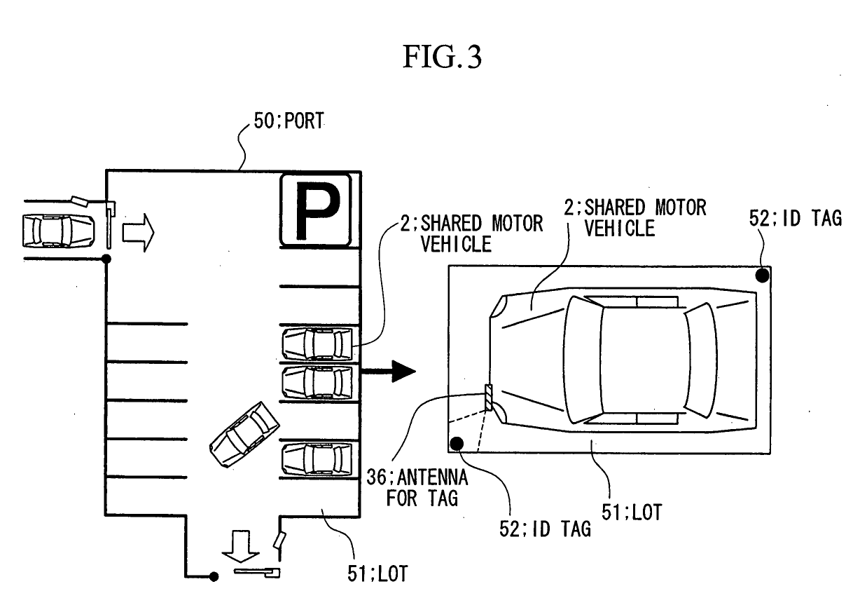

The shared motor vehicle 2 which is parked in the port identifies the lot in the port by the antenna 36 for a tag and the ID tag reader 37. A tag is explained with reference to FIG. 3. As shown in FIG. 3, a plurality of lots 51 are disposed in the port 50 for parking the shared motor vehicles 2. ID tags 52 as devices for transmitting the ID number which is allocated to the port 50 and the lot 51 respectively are disposed on each lot 51.

The ID tag 52 exchanges an original ID number with the antenna 36 for a tag for each port 50 and lot 51 according to a method such as an electromagnetic coupling method, a microwave method, an electrostatic coupling method, or an optical transmitting method. The shared motor vehicle 2 acknowledges positions for the port and the lot where the shared motor vehicle 2 is parked by reading the signal which is received by the antenna 36 for a tag by the ID tag reader 37. Here, as shown in FIG. 3, two ID tags 52 are disposed diagonally in the lot 51 so as to correspond to a front stop and a rear stop of the shared motor vehicle 2. Antenna 36 for tag is disposed a front corner near the ID tag 52 or a rear corner (a left front corner in FIG. 3).

A structure for the shared motor vehicle 2 to acknowledge the positions of the port and the lot where the shared motor vehicle 2 is parked is not limited to the ID tag 52. That is, it may be acceptable if a transmitting-receiving device which is used for an ETC (Electronic Toll Collection) system or a position detector which uses a GPS (Global Positioning System) is used for such a structure.

Next, a staff member controlling operation in the motor vehicle sharing system of the present embodiment is explained with reference to drawings as follows.

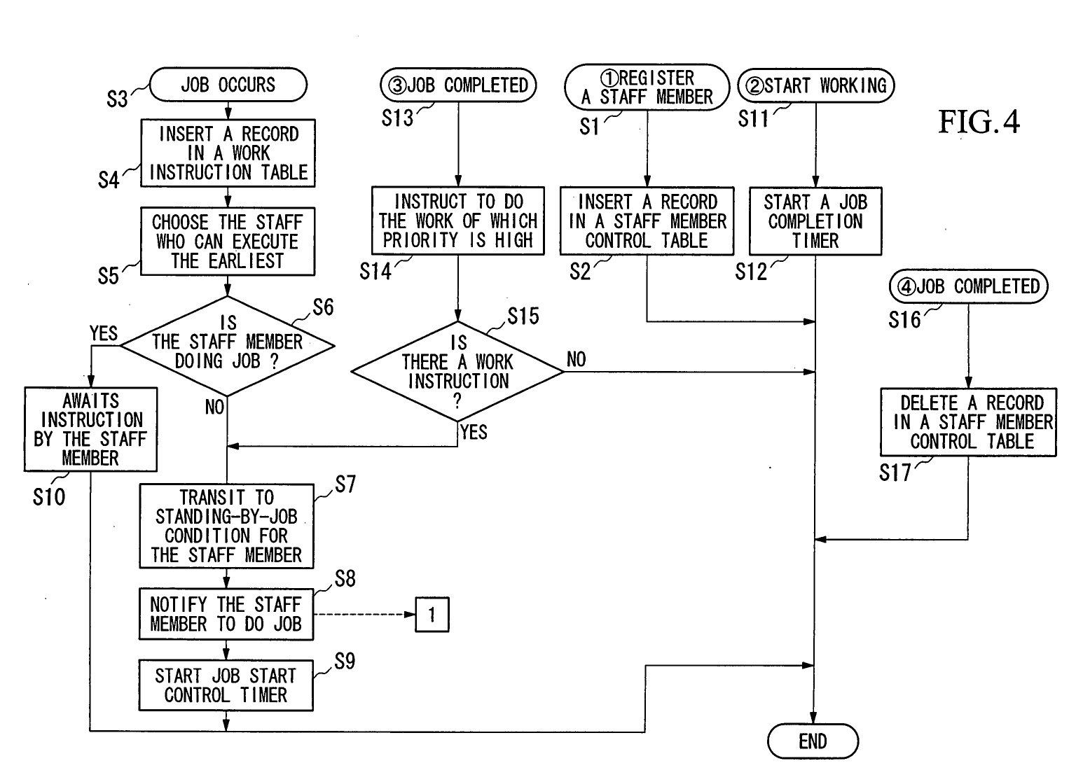

First, a staff member controlling operation in the control center 1 is explained with reference to a flow chart shown in FIG. 4.

First, a staff member 5 reports to the control center 1 from the portable terminal 6 that a daily work starts when the staff member 5 starts the job (step S1). A record is recorded in a staff member control table in the job master 17; thus, the staff member controlling section 102 which is included in the controlling section 11 in the control center 1 starts controlling the staff member (step S2).

In the control center 1, the motor vehicle controlling section 101 which is included in the controlling section 11 acknowledges a maintenance condition of the shared motor vehicle 2 which is notified from the shared motor vehicle 2 so as to be recorded in the motor vehicle master 14 and the port master 15 and a partiality of the motor vehicles in each port. The motor vehicle controlling section 101 detects a staff member's job such as a maintenance and an allocation of the motor vehicle which are supposed to be done by the staff member 5 and a position (job appearance position data) of the port in which there is a job which is to be done by the staff member (step S3).

When a new job occurs, the staff member controlling section 102 adds a record for the occurred job to a job instruction table in the job master 17 (step S4). Also, the staff member controlling section 102 selects a staff member 5 who is estimated to arrive first at the port in which the new job occurs and do the job according to a content which is recorded in the staff member control table in the job master 17 (step S5).

Here, a method for selecting the staff member 5 is explained. In the staff member control table in the job master 17, data which are related to the staff member ID such as (1) portable terminal number, (2) disposition port, (3) job ID, (4) job condition, (5) job start time, and (6) total job time are recorded as explained above. An estimated job completion time is determined by adding a standard job time in which the staff member 5 completes the present job to a time at which the staff member 5 starts the present job according to a standard job time table in which a standard job times for various jobs are recorded in the job master 17 and an inter-port transportation time table in which a standard transportation time between each inter-port distance is recorded. Furthermore, a standard transportation time between the present port and the port in which a new job occurs is added to a estimated job completion time; thus, a estimated arrival time of the staff member 5 for arriving at the port in which the new job occurs is determined. Thus, the staff member who is estimated to arrive at the port first from the present time in which the new job occurs is selected.

After the staff member who is estimated to arrive at the port first in which the new job occurs is selected, it is determined whether or not the staff member 5 is doing the job according to a content which is recorded in the staff member control table in the job master 17 (step S6).

In the step S6, if the staff member 5 is not doing the job (NO in the step S6), the staff member controlling section 102 allocates the job to the staff member 5; thus, a status of the staff member 5 transits to a job start stand-by condition (step S7).

Next, a job notifying section 103 which is included in the controlling section 11 notifies the job to the portable terminal 6 of the staff member 5 (step S8). The staff member controlling section 102 starts a job start monitoring timer and waits for the staff member 5 to start the job (step S9). Here, the job notification in the step S8 corresponds to a command which is received from the control center 1 in an operation of the staff member 5 (step S22).

On the other hand, in the step S6, if the staff member 5 is doing the job (YES in the step S6), the staff member controlling section 102 sets a status of the staff member 5 to be a stand-by-instruction condition (step S10).

Also, when the staff member 5 starts the job and such a report of job start is sent from the portable terminal 6 (step S11), a job completion monitoring timer is started (step S12).

Furthermore, when the staff member 5 completes the instructed job and a report of completion of the job is sent from the portable terminal 6 (step S13), the staff member controlling section 102 selects a job having a priority among the jobs which are recorded in the job instruction table in the job master 17 so as to give a next instruction therefor (step S14).

Next, the staff member controlling section 102 determines whether or not there is a job to which an instruction should be given in a job instruction table in the job master 17 (step S15). If there is a job to which an instruction should be given in a job instruction table in the job master 17 (YES in the step S15), the flow chart goes to the step S7 in which the job is allocated to the corresponding staff member 5 who reported the completion of the job. Thus, a status of the staff member 5 transits to a job start stand-by condition (step S7). Consequently, the above operation is repeated.

On the other hand, if there is not a job to which an instruction should be given in a job instruction table (NO in the step S15), the flow chart waits for the next job to occur.

Also, when the staff member 5 reports that the daily work of the staff member 5 is completed from the portable terminal 6 (step S16), a corresponding record in a staff member control table in the job master 17 is deleted (step S17). Thus, the staff member controlling section 102 completes the control for the staff member; therefore, the status of the staff member is under completed condition of daily work.

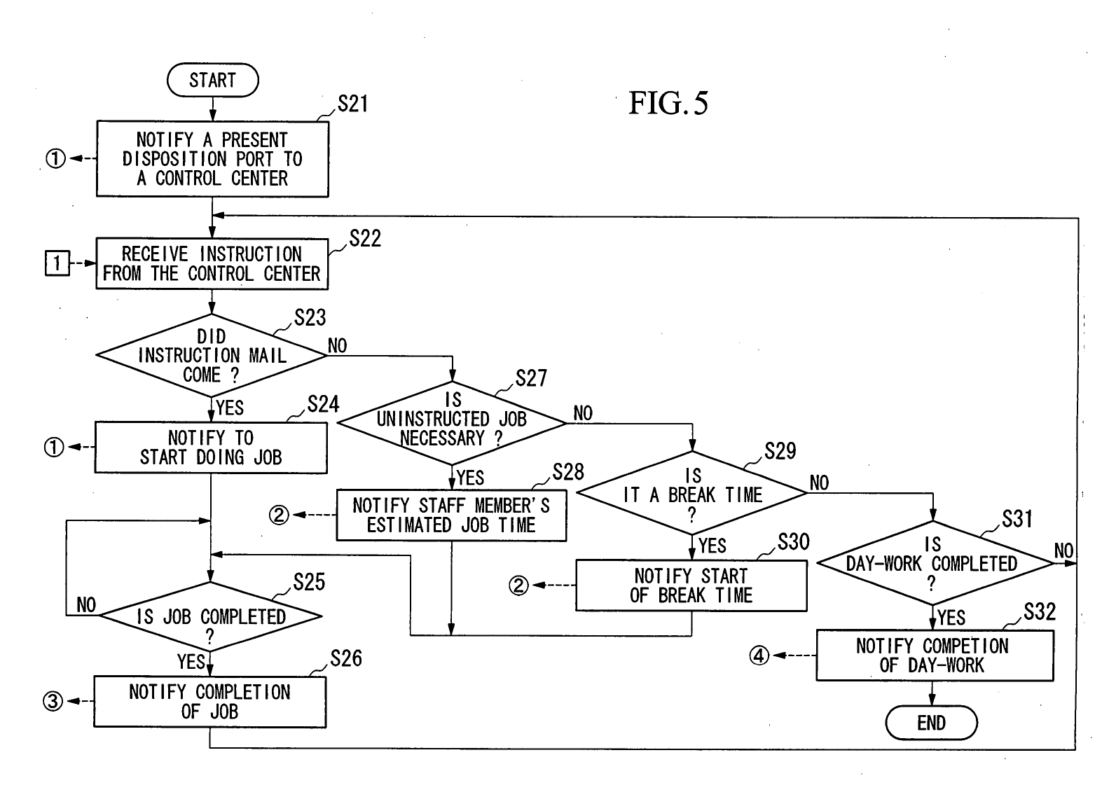

Next, an operation of the staff member 5 who receives an instruction for the job from the control center 1 is explained with reference to a flow chart shown in FIG. 5.

First, when the staff member 5 inputs the present disposition port into the portable terminal 6, the portable terminal 6 notifies the present disposition port for the staff member 5 to the control center 1; thus, the staff member 5 starts a daily work (step S21). Here, the notification of the disposition port in the step S21 corresponds to a staff member registration in an staff member controlling operation in the above control center 1 (step S9).

Next, the portable terminal 6 receives an instruction mail from the control center 1 (step S22) and determines whether or not an instruction mail which instructs a specific job is arriving (step S23). Here, a receipt of the instruction mail in the step S22 corresponds to a job notification to the staff member in a staff member controlling operation in the control center 1 (step S6).

In the step S23, if the instruction mail arrives (YES in the step S23), the staff member transports to the instructed port, and the portable terminal 6 notifies the job start which is inputted by the staff member 5 who acknowledged the instruction mail to the control center 1 (step S24); thus, the staff member 5 starts the job. Here, the notification of the job start in the step S24 corresponds to a job start in the staff member controlling operation in the above control center 1 (step S11).

After the job start is notified to the control center 1, the portable terminal 6 determines the job completion of the staff member 5 (step S25), awaits the completion of the determination (NO in the step S25), notifies the job completion which is inputted by the staff member 5 who completed the job to the control center 1 (step S26). The flow chart goes back to the step S22, the portable terminal 6 awaits a receipt of a new instruction mail. Here, the notification of the job completion in the step S26 corresponds to a job completion in the staff member controlling operation in the control center 1 (step S13).

On the other hand, in the step S23, if an instruction mail which instructs a specific job does not arrive (NO in the step S23), the portable terminal 6 awaits a determination for whether or not an uninstructed job needs to be done by the staff member 5 (step S27). If it is determined that an uninstructed job needs to be done by the staff member 5 (YES in the step S27), a job time which is estimated by the staff member which is inputted by the staff member 5 is notified to the control center 1 (step S28). Here, the notification of the job time which is estimated by the staff member in the step S28 corresponds to a job start in the staff member controlling operation in the above control center 1 (step S11). Also, here, an uninstructed job is registered to the system by the staff member in the port spontaneously. For example, a job for handling a facility in the port and an accident found in the shared motor vehicle 2 can be mentioned.

Also, in the step S27, if it is determined that the uninstructed job need not be done by the staff member 5 (NO in the step S27), the portable terminal 6 awaits a determination for whether the staff member 5 is taking a break time (step S29). If it is determined that the staff member 5 is taking a break (YES in the step S29), the start of break time which is inputted by the staff member 5 is notified to the control center 1 (step S30). Here, the notification of the start of the break time in the step S30 corresponds to a job start in the staff member controlling operation in the control center 1 (step Also, in the step S29, if it is determined that the staff member 5 is not taking a break (NO in the step S29), the portable terminal 6 awaits a determination of whether or not the staff member 5 completes the daily work (step S31). If it is determined that the staff member 5 completes the daily work (YES in the step S31), it is notified to the control center 1 that the daily work of the staff member 5 is completed (step S32). Here, the notification of the daily work completion in the step S32 corresponds to a job start in the staff member controlling operation in the above control center 1 (step S11).

Also, in the step S31, if it is determined that the staff member 5 does not complete the daily work (NO in the step S31), a flow chart goes back to the step S22 in which the portable terminal 6 waits for a new job instruction mail to be received.

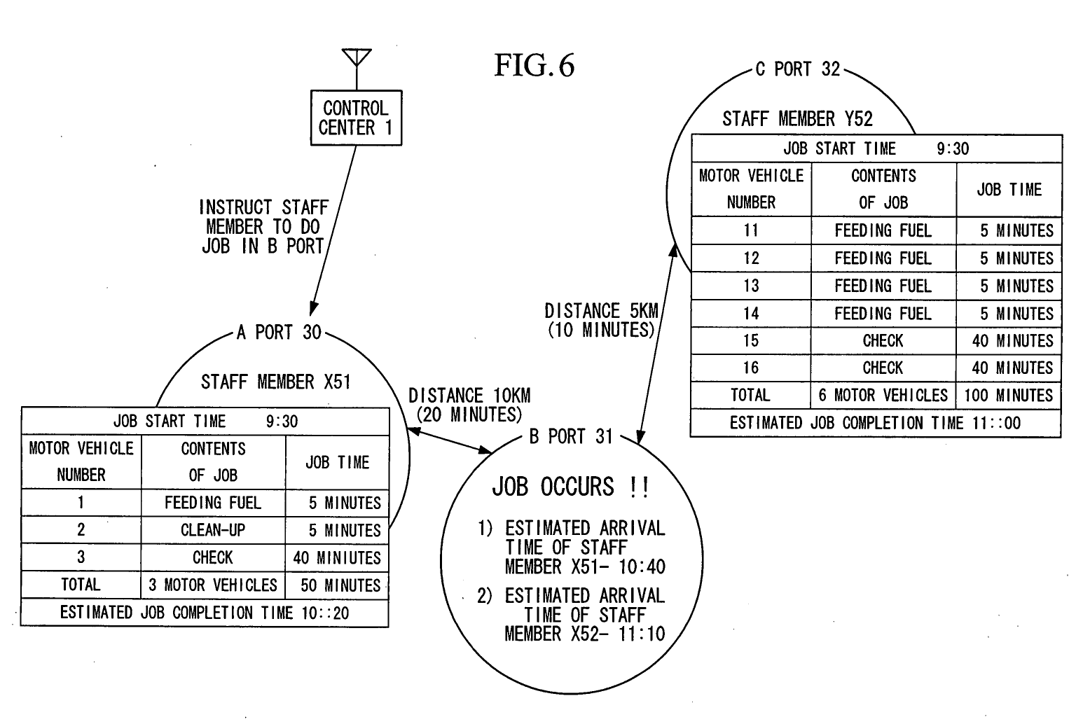

FIG. 6 is an example of a staff member controlling operation in the motor vehicle sharing system in the present embodiment. For example, at present, it is assumed that a new staff member's job occurs in a B port 31 when a staff member X51 is doing a job in an A port 30 and a staff member Y51 is doing job in a C port 32.

In this case, it is assumed that it is recorded with reference to a standard job time table in which a standard job time for each staff member is recorded in the staff member control table in the job master 17 as follows.

(1) for staff member X51

Job start time 9:30

motor vehicle No.: 1, job contents: feeding fuel, job time 5 min.

motor vehicle No.: 2, job contents: clean-up, job time 5 min.

motor vehicle No.: 3, job contents: check, job time 40 min.

estimated job completion time: 10:20

(2) for staff member Y52

Job start time 9:20

motor vehicle No.: 11, job contents: feeding fuel, job time 5 min.

motor vehicle No.: 12, job contents: feeding fuel, job time 5 min.

motor vehicle No.: 13, job contents: feeding fuel, job time 5 min.

motor vehicle No.: 14, job contents: feeding fuel, job time 5 min.

motor vehicle No.: 15, job contents: check, job time 40 min.

motor vehicle No.: 16, job contents: check, job time 40 min.

estimated job completion time: 11:00

Also, if it is recorded as follows in an inter-port transportation time table in which a standard transportation time among each inter-port distances are recorded in the job master 17

(1) A port⇄B port: distance 10 km, transportation time 20 min.

(2) B port→C port: distance 5 km, transportation time 10 min.

an estimated time of arrival by the staff member X51 and the staff member Y52 at the B port are as follows

(1) estimated arrival time of staff member X51: 10:40

(2) estimated arrival time of staff member Y52: 11:10

Therefore, it is understood that the staff member can do the job efficiently if the control center 1 gives job instructions for the staff member 5 to do the job in the B port even if it is distant.

Here, in the above embodiment, explanations are made for a case in which a next job instruction is given after the staff member completes the present job. More importantly, it may be acceptable for a job instruction to be given so as to interrupt the staff member's job which can be interrupted if a job with greater priority arises.

Also, the following may be acceptable. That is, in the job start monitoring timer and a job completion monitoring time, a time until the staff member starts the instructed job and at which time the job is completed are monitored respectively. If the staff member does not start the job nor complete the job in a predetermined time, a warning is issued in the control center 1 so as to let the staff member who is supposed to be under an instructed status check a current status. Similarly, it may be acceptable for a warning to be issued in the control center 1 by disposing a monitoring timer for monitoring a transportation time of the staff member so as to let the staff member check a current status when the staff member cannot transport the job position at a predetermined time.

### Industrial Applicability

As explained above, according to the present invention, a job content and the job start time of the staff member are acknowledged. The estimated job completion time is determined according to the standard job time for each job. Furthermore, the present job position of the staff member is acknowledged, and a transportation time for arriving at a position in which a new job occurs is determined according to the standard transportation time between the ports. According to an integral analysis for the estimated job completion time and the transportation time, the staff member who is the most suitable for the newly occurred job is selected. An instruction for the next job is given to the portable terminal of the staff member; thus, it is possible to control and shorten a loss in a standing-by-job time and a transportation time by the staff member to a minimum level so as to improve an efficiency of the job by the staff member. Therefore, it is possible to do more jobs, unless the number of the staff member is changed. Also, it is possible to complete the job by a fewer staff members unless job load is changed.

Also, it is possible to reduce costs which are caused in transportation so as to improve a profitability of the business by avoiding unnecessary transportation.

1. A motor vehicle sharing system, for controlling a plurality of motor vehicles such that the motor vehicles can be used by a plurality of users while maintaining condition of a plurality of the motor vehicles which are parked in a plurality of parking areas, which are called ports, by directing a plurality of staff members such that the motor vehicles are rentable, comprising:
a controlling device which can transmit and receive motor vehicle data which includes present position data of the motor vehicle and maintenance condition of motor vehicles,
wherein the controlling device comprises:
a data storing section which stores a present position data for the staff member and a job data which are notified from a terminal of the staff member as a staff member data;
a motor vehicle controlling section which detects a position of a port in which a staff member's job such as maintenance and reallocation of motor vehicles which are supposed to be done by the staff members occur from the motor vehicle data as a job appearance position data;
a staff member controlling section which selects a staff member who is estimated to be able to arrive at a port which is shown by job appearance position data in a shortest required time among a plurality of the staff members according to the staff member data and the job appearance position data; and
a job notifying section which notifies the job appearance position data to a terminal of the staff member which is selected by the staff member controlling section.

2. A motor vehicle sharing system according to claim 1, wherein:
the data storing section further stores a standard transportation time which is predetermined for each port, and
the staff member controlling section determines the required time according to the standard transportation time.

3. A motor vehicle sharing system according to claim 1 or 2, wherein:
the data storing section further stores a standard job time which is predetermined for each staff member's job; and
the staff member controlling section determines the required time according to the standard job time.

4. A motor vehicle sharing system according to any one of claims 1 to 3 wherein a monitor timer for monitoring a time which is required for each staff member to be at a job position and start the job which is notified from the terminal of the staff member and a monitoring section which issues a warning that the staff member is not at the job position and start the job in the predetermined time are disposed in the staff member controlling section.
